(19) United States
(12) Patent Application Publication
(10) Pub. No.: US 2006/0152485 A1
(43) Pub. Date: Jul. 13, 2006

(54) Electronic equipment and input control method

(75) Inventors: Nobuyuki Kobayashi, Kawasaki (JP); Satoshi Abe, Kawasaki (JP); Katsunori Masamune, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/119,781

(22) Filed: May 3, 2005

(30) Foreign Application Priority Data
Jan. 13, 2005 (JP) 2005-006318

(51) Int. Cl. G09G 5/08

(52) U.S. Cl. 345/157

(57) ABSTRACT

In electronic equipment comprising input devices of a stick-like pointing device and a pad-like pointing device, and a controller that controls a manipulation performed on the pad-like pointing device as a manipulation performed on a button during a predetermined time after the stick-like pointing device is completed. Owing to this feature, electronic equipment offering excellent maneuverability can be provided without an increase in the number of operation buttons.

### CROSS-REFERENCE TO RELATED APPLICATION

This application claims priority from, and incorporates by reference the entire disclosure of, Japanese Patent Application

(1) No. 2005-006318, filed on Jan. 13, 2005.

### BACKGROUND OF THE INVENTION

1. Field of the Invention

The present invention relates to electronic equipment or, more particularly, to electronic equipment having the maneuverability of a pointing device improved and to an input control method.

2. Description of the Related Art

In recent years, users have come to employ diverse input devices along with an expansion of the market for notebook personal computers. Accordingly, computer manufacturers are striving to satisfy the users' need for the diverse input devices that are included in the notebook personal computers. Among the input devices, products whose marketability is growing include two products of a stickpoint and a glidepoint, or a touch pad. Commercialization of the products in line with the users' need is in progress. The stickpoint may be referred to as a pointing stick, a trackpoint, or an acupoint, and is a boss-like input device located in the center of a keyboard of a notebook personal computer. By applying force to the input device in any radial direction, a command for moving a mouse cursor on a screen is transferred to a CPU included in a computer. A direction in which the force is applied is equivalent to a moving direction of a mouse, and the intensity of the force is equivalent to the moving speed of the mouse.

On the other hand, the glidepoint may be referred to as a touch pad. The glidepoint is a coordinate-type data input device that when an operator touches the surface of the pad with his/her finger or a stylus, transfers coordinate data, which represents the position on the surface of the pad, to a CPU included in a computer. Equipment including the touch pad has been disclosed (Patent Document 1). In the glidepoint, a moving direction of a mouse cursor and a magnitude of movement thereof are determined based on a change in a point on the pad surface touched by an operator or a change in coordinate data transmitted responsively to the touch.

FIG. 4 shows part of a personal computer in accordance with a related art which includes input devices of both a stickpoint and a glidepoint. In a personal computer body 100 in accordance with the related art which is currently on the market and part of which is shown in FIG. 4, a stickpoint 102 is located in the center of a keyboard 101 incorporated in the personal computer body 100, and a glidepoint 103 is disposed near an operator 104 side in front of the keyboard 101 and incorporated in the personal computer body 100.

Furthermore, as buttons to execute click operations after moving a cursor on the display screen of the computer, which screen is not shown in FIG. 4, glidepoint buttons 105 are disposed near the operator 104 side in front of the glidepoint 103, and stickpoint buttons 106 are interposed between the keyboard 101 and glidepoint 103. Thus, the buttons are located at positions optimal for use of the stickpoint 102 or glidepoint 103. Two pairs of buttons sharing the same capabilities are located at two positions.

The input devices, that is, the keyboard 101, stickpoint 102, glidepoint 103, glidepoint buttons 105, and stickpoint buttons 106 are connected to a microcomputer 200. The microcomputer 200 senses an event that any of the input devices is manipulated, and executes processing according to the event.

[Patent Document 1 Paragraphs [06], [10], [19], and [0115], and Drawings [FIG. 1], [FIG. 2], and FIG. 4 in Japanese Unexamined Patent Application Publication No. 9-6534 (corresponding to U.S. Priority Claim No. 474064)

Among personal computers put on the market earlier than the personal computer 100 in accordance with the related art which is partly shown in FIG. 4, a personal computer including both the stickpoint 102 and glidepoint 103 is provided with the glidepoint buttons 105 but not provided with the stickpoint buttons 106. Therefore, when the stickpoint 102 is manipulated, as a right button and a left button included as the glidepoint buttons 105 are located far away from the keyboard 101, maneuverability is quite poor. In efforts to solve this problem, as shown in FIG. 4, a right button and a left button that are included as the stickpoint buttons 106 are newly disposed above the glidepoint 103. However, in this case, the number of operation buttons increases as a whole. Consequently, as the space for additional buttons must be preserved, an increase in a cost ensues.

### SUMMARY OF THE INVENTION

In order to solve the foregoing problems, an object of the present invention is to provide electronic equipment offering excellent maneuverability without an increase in the number of operation buttons as a whole and to an input control method.

A computer system in accordance with the present invention for accomplishing the above object is electronic equipment comprising both a stick-like pointing device and a pad-like pointing device and a controller that controls a manipulation performed on the pad-like pointing device is controlled as a manipulation performed on a button during a predetermined period of time after the stick-like pointing device has been manipulated. Specifically, after the stick-like pointing device is manipulated, if either of right and left regions into which the surface of the pad-like pointing device is divided is touched, the right or left region acts as a button. In the electronic equipment, within the predetermined time after the stick-like pointing device is manipulated, a manipulation performed on the pad-like pointing device is controlled as a manipulation performed on a button.

An input control method in accordance with the present invention for accomplishing the aforesaid object is an input control method to be implemented in electronic equipment comprising a stick-like pointing device and a pad-like pointing device. Herein, an input from the stick-like pointing device is monitored. If a manipulation performed on the stick-like pointing device is detected, the action modes of the pad-like pointing device are switched from a normal first action mode to a second action mode different from the first action mode, and the pad-like pointing device is held in the second action mode until a predetermined time elapses after the manipulation performed on the stick-like pointing device is detected. Data representing a manipulated position on the pad-like pointing device within a manipulating field of the pad-like pointing device is received. Either of the regions, into which the manipulating field of the pad-like pointing device is segmented, containing the manipulated position is identified. A manipulation to be performed on a button associated in advance with the identified region is carried out. After the predetermined time has elapsed, the pad-like pointing device is returned from the second action mode to the first action mode.

According to the input control method, the second action mode is a mode in which a manipulation to be performed on a button associated with either of the regions, into which the manipulating field of the pad-like pointing device is segmented, containing an input position, is carried out during a period during which a manipulation performed on the pad-like pointing device is recognized as a manipulation performed on a button.

According to the input control method, the manipulating field of the pad-like pointing device is segmented into two regions of right and left regions.

A program in accordance with the present invention for accomplishing the aforesaid object is a program to be run in electronic equipment comprising a stick-like pointing device and a pad-like pointing device. Herein, the program implements the foregoing input control method in the electronic equipment.

According to the electronic equipment, input control method, and program for implementing the method, right and left buttons need not be included in equipment, which comprises a stick-like pointing device and a pad-like pointing device, for the stick-like pointing device (stickpoint) interposed between the keyboard and the pad-like pointing device (glidepoint). Consequently, excellent maneuverability is ensured without an increase in the number of operation buttons.

### BRIEF DESCRIPTION OF THE DRAWINGS

FIG. 1 is a block diagram showing part of electronic equipment in accordance with the present invention comprising both a stick-like pointing device and a pad-like pointing device;

FIG. 2A and FIG. 2B show the appearance of the electronic equipment in accordance with the present invention, FIG. 2A is a perspective view, and FIG. 2B is an enlarged view of an operating unit;

FIG. 3 is a flowchart describing a manipulation-on-pointing device processing routine employed in the present invention; and

FIG. 4 shows part of a personal computer in accordance with a related art comprising input devices of both a stickpoint and a glidepoint.

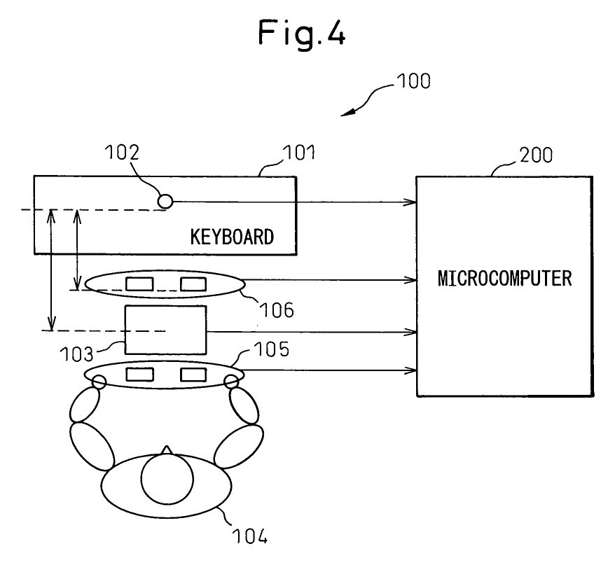

### DESCRIPTION OF THE PREFERRED EMBODIMENTS

Referring to the drawings, an embodiment of the present invention will be described below.

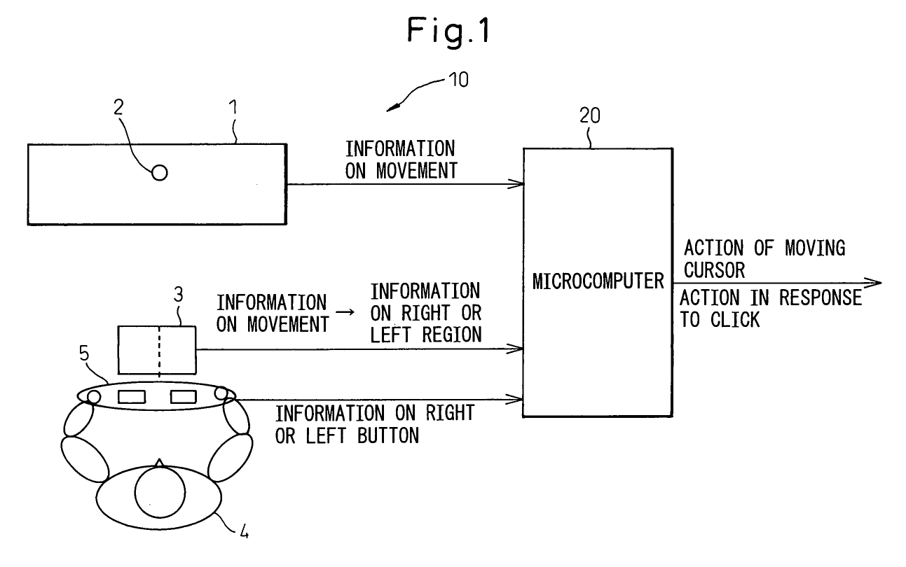

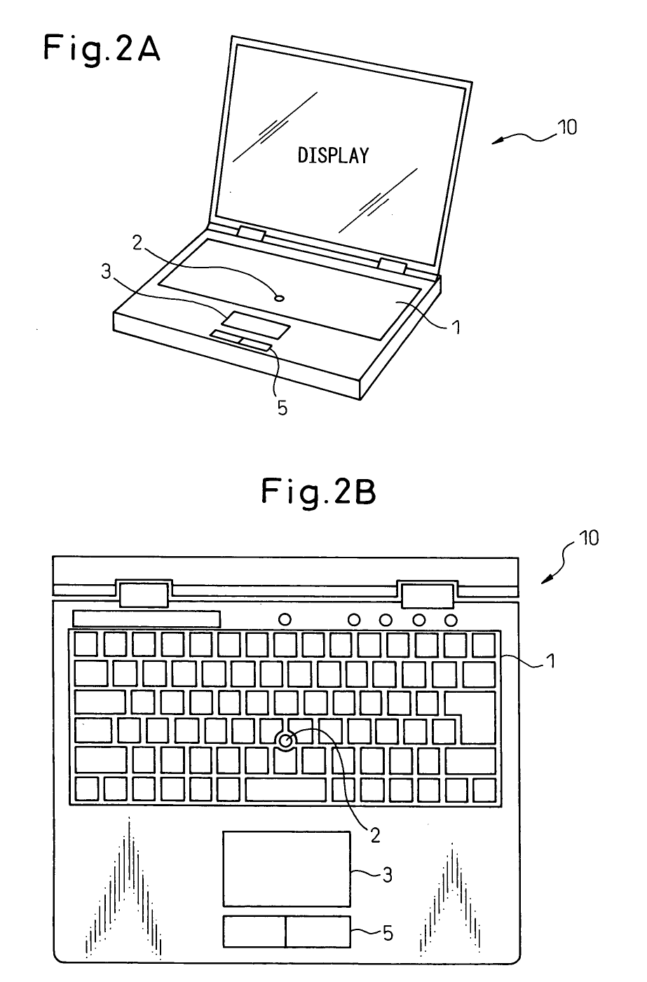

FIG. 1 is a block diagram showing part of electronic equipment in accordance with the present invention comprising input devices of both a stick-like pointing device and a pad-like pointing device. FIG. 2A and FIG. 2B show the appearance of the electronic equipment in accordance with the present invention. FIG. 2A is a perspective view, and FIG. 2B is an enlarged view of an operating unit. In a personal computer that is an example of the electronic equipment in accordance with the present invention part of which is shown in FIG. 1, a stickpoint 2 (or a stick-like pointing device) is located in the center of a keyboard 1 incorporated in a personal computer body 10. A glidepoint 3 (or a pad-like pointing device) is located near an operator 4 side in front of the keyboard 1 and incorporated in the personal computer body 10. Glidepoint buttons 5 are, as shown in FIG. 2B, located near the operator 4 side in front of the glidepoint 3 as buttons to be clicked in relation to a mouse pointer that moves on the display screen of a computer display shown in FIG. 2A.

The input devices, that is, the keyboard 1, stickpoint 2, glidepoint 3, and glidepoint buttons 5 are connected to a microcomputer 20. The microcomputer 20 receives an event that any of the input devices is manipulated, and executes processing accordingly.

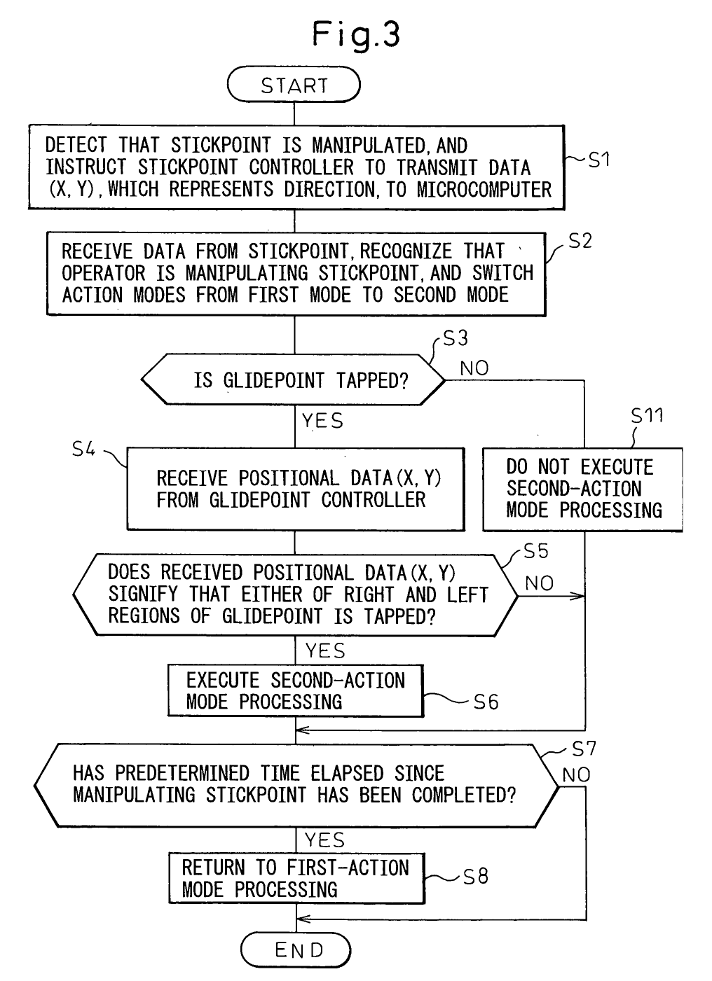

FIG. 3 is a flowchart describing a manipulation-on-pointing device processing routine employed in the present invention. According to the present invention, during a certain period of time immediately after the stickpoint 2 is manipulated, the glidepoint 3 does not act in a normal action mode (in which the glidepoint is manipulated in order to move a mouse pointer), but acts in a button action mode in which the glidepoint is used as two (right and left) buttons (in which the glidepoint is manipulated as if to click a mouse button). Specifically, when a tap is made in the left region of the glidepoint, similarly to when the left button of a mouse is clicked, an application program whose name is indicated by a mouse pointer is run or started, or a link established over the Internet is traced. When a tap is made in the right region of the glidepoint, similarly to when the right button of the mouse is clicked, a relevant menu is displayed at a position indicated by the mouse pointer. This obviates the necessity of interposing stickpoint buttons between the keyboard 1 and glidepoint 3. The glidepoint 3 acts like the stickpoint buttons. Consequently, the space for incorporation of another circuit need not be preserved, and the number of parts decreases. This results in a reduction in a cost and excellent maneuverability.

Now, a description will be made in conjunction with the flowchart of FIG. 3.

At step S1, when the operator 4 manipulates the stickpoint 2, a stickpoint controller incorporated in the stickpoint 2 transmits two-dimensional data (X, Y), which represents a radial direction on the screen in which a mouse cursor is moved, to the microcomputer 20.

At step S2, the microcomputer 20 receives the data from the stickpoint 2, recognizes that the operator 4 is manipulating the stickpoint 2, and switches the action modes of the glidepoint from the first action mode to the second action mode. What is referred to as the first action mode is a mode in which the microcomputer 20 recognizes the action mode of the glidepoint 3 as a normal action mode (in which the grindpoint is manipulated in order to move a mouse pointer). What is referred to as the second action mode is a button action mode in which the microcomputer 20 recognizes that the glidepoint 3 is used as a button (the glidepoint is manipulated as if to click a mouse button).

At step S3, a glidepoint controller incorporated in the glidepoint 3 determines whether the glidepoint 3 has been tapped or a finger has been dragged on the glidepoint. If the glidepoint controller determines that the glidepoint has been tapped, control is passed to step S4. If the glidepoint controller determines that a finger has been dragged on the glidepoint, control is passed to step S11. Herein, the glidepoint controller monitors a time interval during which the glidepoint 3 is continuously touched by the operator 4. The glidepoint controller determines based on the time interval whether the operator 4 has tapped the glidepoint 3 or the operator has dragged his/her finger on the glidepoint.

At step S4, after the glidepoint controller determines that the operator 4 has tapped the glidepoint 3, the glidepoint controller incorporated in the glidepoint 3 transfers two-dimensional coordinate data (X, Y), which represents a manipulated position on the glidepoint 3, to the microcomputer 20.

At step S5, the microcomputer 20 checks the data, which represents the manipulated position (X, Y) on the glidepoint 3 and is received from the grindpoint controller, to see if either of the left half of the glidepoint 3 and the right half thereof is tapped. If the determination is made in the affirmative, control is passed to step S6. If the determination is made in the negative, control is passed to step S7.

At step S6, the microcomputer 20 executes second-action mode processing.

At step S7, the microcomputer 20 determines whether a predetermined time, for example, 2 sec has elapsed since manipulating the stickpoint 2 has been completed. If the determination is made in the affirmative, control is passed to step S8. If the determination is made in the negative, the routine is terminated.

At step S8, as the predetermined time is determined to have elapsed, the microcomputer 20 returns from the second-action mode processing to execution of first-action mode processing.

At step S11, as the glidepoint controller has determined that the operator 4 has dragged his/her finger on the glidepoint 3 but has not tapped the glidepoint 3, the microcomputer 20 ignores the second-action mode processing, does not execute it and passes control to step S7.

As mentioned above, during a certain period of time after manipulating the stickpoint 2 is completed, the microcomputer 20 does not read information received from the glidepoint 3 as information on the movement of a cursor but reads it as information required for permitting the glidepoint to act as a button (as if to click a mouse button). If a tap is made in the left-hand region of the surface of the glidepoint 3, the microcomputer 20 recognizes it as depression of a left button. If a tap is made in the right-hand region of the surface of the glidepoint 3, the microcomputer 20 recognizes it as depression of a right button.

As for the electronic equipment in accordance with the related art comprising both the stickpoint and glidepoint, as the glidepoint buttons located near an operator side in front of the glidepoint is separated far away from the stickpoint, when the stickpoint is manipulated, maneuverability is quite poor. According to the present invention, since the right and left regions of the contact surface of the glidepoint 3 located near the stickpoint 2 are used as buttons, a distance by which a finger is moved from the stickpoint 2 is shortened. This leads to improved maneuverability.

Moreover, according to the present invention, it is unnecessary to interpose stickpoint buttons between the keyboard 1 and glidepoint 3 for the purpose of overcoming the aforesaid drawbacks. In other words, the number of buttons need not be increased. The space for added buttons need not be preserved. Eventually, the cost required for the addition of buttons can be eliminated.

### APPENDICES

1. Electronic equipment comprising a stick-like pointing device and a pad-like pointing device, wherein:
a manipulation performed on the pad-like pointing device is controlled as a manipulation performed on a button during a predetermined time after manipulating the stick-like pointing device is completed.

2. The electronic equipment according to appendix 1, wherein the electronic equipment is a notebook computer.

3. An input control method implemented in electronic equipment comprising a stick-like pointing device and a pad-like pointing device, wherein:
a manipulation performed on the pad-like pointing device is controlled as a manipulation performed on a button during a predetermined time after manipulating the stick-like pointing device is completed.

4. A program to be run in electronic equipment comprising a stick-like pointing device and a pad-like pointing device, wherein:
the program instructs the electronic equipment to control a manipulation performed on the pad-like pointing device as a manipulation performed on a button during a predetermined time after manipulating the stick-like pointing device is completed.

5. An input control method implemented in electronic equipment comprising a stick-like pointing device and a pad-like pointing device, comprising the steps of:
monitoring an input sent from the stick-like pointing device;
if a manipulation performed on the stick-like pointing device is detected, switching the action modes of the pad-like pointing device from a normal first action mode to a second action mode different from the first action mode, and holding the pad-like pointing device in the second action mode until a predetermined time elapses after the manipulation is detected;
receiving data that represents a manipulated position on the pad-like pointing device within a manipulating field of the pad-like pointing device;
identifying either of the regions, into which the manipulating field of the pad-like pointing device is segmented in advance, containing the manipulated position;
carrying out a manipulation to be performed on a button associated in advance with the identified region; and
returning the pad-like pointing device from the second action mode to the first action mode after the predetermined time has elapsed.

6. The input control method according to appendix 5, wherein the second action mode is a mode in which a manipulation to be performed on a button associated with either of the regions, into which the manipulating field of the pad-like pointing device is segmented, containing an input position is carried out during a period during which a manipulation performed on the pad-like pointing device is recognized as a manipulation performed on a button.

7. The input control method according to appendix 5 or 6, wherein the first action mode is a mode in which a manipulation to be performed on a mouse in order to move a cursor is carried out.

8. The input control method according to any one of appendices 5 to 7, wherein the second action mode is a mode in which a manipulation of clicking a mouse is carried out.

9. The input control method according to any one of appendices 5 to 8, wherein the manipulating field of the pad-like pointing device is segmented into two regions, right and left.

10. The input control method according to any one of appendices 5 to 8, wherein the manipulating field of the pad-like pointing device is segmented into two regions, upper and lower.

11. The input control method according to any one of appendices 5 to 8, wherein the manipulating field of the pad-like pointing device is segmented into four regions, upper, lower, right, and left.

12. The input control method according to any one of appendices 5 to 11, wherein the electronic equipment is a notebook computer.

13. A program to be run in electronic equipment comprising a stick-like pointing device and a pad-like pointing device, the program instructing the electronic equipment to follow the steps of:
monitoring an input sent from the stick-like pointing device;
if a manipulation performed on the stick-like pointing device is detected, switching the action modes of the pad-like pointing device from a normal first action mode to a second action mode different from the first action mode, and holding the pad-like pointing device in the second action mode until a predetermined time elapses after the manipulation is detected;
receiving data that represents a manipulated position on the pad-like pointing device within a manipulating field of the pad-like pointing device;
identifying either of regions, into which the manipulating field of the pad-like pointing device is segmented, containing the manipulated position;
carrying out a manipulation to be performed on a button associated in advance with the identified region; and
returning the pad-like pointing device from the second action mode to the first action mode after the predetermined time has elapsed.

14. The program according to appendix 13, wherein the second action mode is a mode in which a manipulation to be performed on a button associated with either of the regions, into which the manipulating field of the pad-like pointing device is segmented, containing an input position is carried out during a period during which a manipulation performed on the pad-like pointing device is recognized as a manipulation performed on a button.

15. The program according to appendix 13 or 14, wherein the first action mode is a mode in which a manipulation to be performed on a mouse in order to move a cursor is carried out.

16. The program according to any one of appendices 13 to 15, wherein the second action mode is a mode in which a manipulation of clicking a mouse is carried out.

17. The program according to any one of appendices 13 to 16, wherein the electronic equipment is a notebook computer.

18. An input control unit included in electronic equipment comprising a stick-like pointing device and a pad-like pointing device, comprising:
a monitoring block that monitors an input sent from the stick-like pointing device;
a switching block that if a manipulation performed on the stick-like pointing device is detected, switches the action modes of the pad-like pointing device from a normal first action mode to a second action mode different from the first action mode, and holds the pad-like pointing device in the second action mode until a predetermined time elapses after the manipulation is detected;
a data receiving block that receives data which represents a manipulated position on the pad-like pointing device within a manipulating field of the pad-like pointing device;
an identifying block that identifies either of regions, into which the manipulating field of the pad-like pointing device is segmented in advance, containing the manipulated position;
a working block that carries out a manipulation to be performed on a button associated in advance with the specified region; and
a returning block that returns the pad-like pointing device from the second action mode to the first action mode after the predetermined time has elapsed.

19. The input control unit according to appendix 18, wherein the second action mode is a mode in which a manipulation to be performed on a button associated with either of the regions, into which the manipulating field of the pad-like pointing device is segmented, containing an input position is carried out during a period during which a manipulation performed on the pad-like pointing device is recognized as a manipulation performed on a button.

20. The input control unit according to appendix 17 or 18, wherein the first action mode is a mode in which a manipulation to be performed on a mouse in order to move a cursor is carried out.

21. The input control unit according to any one of appendices 18 to 20, wherein the second action mode is a mode in which a manipulation of clicking a mouse is carried out.

22. The input control unit according to any one of appendices 18 to 21, wherein the manipulating field of the pad-like pointing device is segmented into two regions, right and left.

23. The input control unit according to any one of appendices 18 to 21, wherein the manipulating field of the pad-like pointing device is segmented into two regions, upper and lower.

24. The input control unit according to any one of appendices 18 to 21, wherein the manipulating field of the pad-like pointing device is segmented into four regions, upper, lower, right and left.

25. The input control unit according to any one of appendices 18 to 24, wherein the electronic equipment is a notebook computer.

What is claimed is:

1. Electronic equipment comprising:
a stick-like pointing device and a pad-like pointing device; and
a controller that controls a manipulation performed on the pad-like pointing device as a manipulation performed on a button during a predetermined time after manipulating the stick-like pointing device is completed.

2. The electronic equipment according to claim 1, wherein the electronic equipment is a notebook computer.

3. An input control method implemented in electronic equipment comprising a stick-like pointing device and a pad-like pointing device,
controlling a manipulation performed on the pad-like pointing device as a manipulation performed on a button during a predetermined time after manipulating the stick-like pointing device is completed.

4. An input control method implemented in electronic equipment comprising a stick-like pointing device and a pad-like pointing device, comprising the steps of:
monitoring an input sent from the stick-like pointing device;
if a manipulation performed on the stick-like pointing device is detected, switching the action modes of the pad-like pointing device from a normal first action mode to a second action mode different from the first action mode, and holding the pad-like pointing device in the second action mode until a predetermined time elapses after the manipulation is detected;
receiving data that represents a manipulated position on the pad-like pointing device within a manipulating field of the pad-like pointing device;
identifying either of the regions, into which the manipulating field of the pad-like pointing device is segmented in advance, containing the manipulated position;
carrying out a manipulation to be performed on a button associated in advance with the identified region; and
returning the pad-like pointing device from the second action mode to the first action mode after the predetermined time has elapsed.

5. The input control method according to claim 4, wherein the second action mode is a mode in which a manipulation to be performed on a button associated with either of the regions, into which the manipulating field of the pad-like pointing device is segmented, containing an input position is carried out during a period during which a manipulation performed on the pad-like pointing device is recognized as a manipulation performed on a button.

6. The input control method according to claim 4, wherein the first action mode is a mode in which a manipulation to be performed on a mouse in order to move a cursor is carried out.

7. The input control method according to claim 4, wherein the second action mode is a mode in which a manipulation of clicking a mouse is carried out.

8. The input control method according to claim 4, wherein the manipulating field of the pad-like pointing device is segmented into two regions, right and left.

9. The input control method according to claim 4, wherein the manipulating field of the pad-like pointing device is segmented into two regions, upper and lower.

10. The input control method according to claim 4, wherein the manipulating field of the pad-like pointing device is segmented into four regions, upper, lower, right, and left.

11. The input control method according to claim 4, wherein the electronic equipment is a notebook computer.
